(19) United States
(12) Patent Application Publication
(10) Pub. No.: US 2013/0057123 A1
(43) Pub. Date: Mar. 7, 2013

(54) ROTOR ASSEMBLY FOR MOTOR AND MOTOR INCLUDING THE SAME

(71) Applicant: Sang Jae Song, Suwon (KR)

(72) Inventor: Sang Jae Song, Suwon (KR)

(73) Assignee: SAMSUNG ELECTRO-MECHANICS CO., LTD., Suwon (KR)

(21) Appl. No.: 13/602,525

(22) Filed: Sep. 4, 2012

(30) Foreign Application Priority Data
Sep. 7, 2011 (KR) 10-2011-0090674

(51) Int. Cl. G11B 17/02; H02K 7/00

(52) U.S. Cl. 310/75 R; G9B/17.002

(57) ABSTRACT

There is provided a rotor assembly for a motor and a motor including the same, the rotor assembly including: a hub including a magnet electromagnetically interacting with a coil to generate rotational driving force; and a disk mounting part included in the hub and having a disk mounted thereon, wherein contact surfaces of the disk and a contact part that contacts the disk are formed of the same material, have the same roughness, and are coupled to each other.

### CROSS-REFERENCE TO RELATED APPLICATIONS

This application claims the priority of Korean Patent Application No. 10-2011-0090674 filed on Sep. 7, 2011, in the Korean Intellectual Property Office, the disclosure of which is incorporated herein by reference.

### BACKGROUND OF THE INVENTION

1. Field of the Invention

The present invention relates to a rotor assembly for a motor and a motor including the same, and more particularly, to a rotor assembly for a motor capable of improving performance and a lifespan thereof by preventing distortion of a disk after the disk is mounted thereon, and a motor including the same.

2. Description of the Related Art

A hard disk drive (HDD), an information storage device, reads data stored on a disk or writes data to a disk using a read/write head.

The hard disk drive requires a disk driving device capable of driving the disk Tri the disk driving device, a small-sized motor is used.

In the small-sized motor, a hydrodynamic bearing assembly has been used. A shaft, a rotating member of the hydrodynamic bearing assembly, and a sleeve, a fixed member thereof, have oil interposed therebetween, such that the shaft is supported by fluid pressure generated in the oil.

The motor may have a disk, on which data maybe stored, mounted thereon. As capacity of a hard disk drive increases, precision of components configuring the hard disk drive should be improved.

In particular, it is important for a head to be maintained at a predetermined flying height along a stroke path of an actuator between inner and outer data regions of a disk surface in a head slider in order to improve the precision of the hard disk drive.

However, the disk or the hub may be warped due to pressure applied by a clamping member clamping the disk against a surface on which the disk is mounted or due to a weight of the disk at the time of mounting the disk, which deteriorates rotational precision of the disk.

Therefore, research into a technology for preventing warpage of a disk or a hub at the time of mounting the disk in order to significantly improve performance and a lifespan of a motor by improving rotational precision of the disk has been urgently demanded

### SUMMARY OF THE INVENTION

An aspect of the present invention provides a rotor assembly for a motor capable of significantly improving performance and a lifespan of a motor by fixing a disk to a hub without a separate member to prevent warpage of the disk and the hub and improve coupling force therebetween, and a motor including the same.

According to an aspect of the present invention, there is provided a rotor assembly for a motor, including: a hub including a magnet electromagnetically interacting with a coil to generate rotational driving force; and a disk mounting part included in the hub and having a disk mounted thereon, wherein contact surfaces of the disk and a contact part that contacts the disk have a degree of flatness in a range of 0 nm or more to 20 nm or less and are coupled to each other.

According to another aspect of the present invention, there is provided a rotor assembly for a motor, including: a hub including a magnet electromagnetically interacting with a coil to generate rotational driving force; and a disk mounting part included in the hub and having a disk mounted thereon, wherein the disk and a contact part that contacts the disk are coupled to each other by an optical contact bonding.

The disk and the contact part that contacts the disk may he formed of the same material.

The contact part maybe a disk mounting part or a space allowing the disk mounting part and the disk to be spaced apart from each other.

The disk and the contact part may surface-contact each other.

The contact surfaces of the disk and the contact part that contacts the disk may be formed of aluminum (Al).

According to another aspect of the present invention, there is provided a spindle motor including: the rotor assembly for a motor as described above; a sleeve supporting a shaft rotating together with the hub; and a base coupled to the sleeve and having a core coupled thereto, the core having the coil wound theraround.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor including a rotor assembly for a motor according to an embodiment of the present invention;

FIG. 2 is a schematic cut-away exploded perspective view showing the rotor assembly for a motor according to the embodiment of the present invention.

FIG. 3 is a graph showing adhesion between a disk mounting part of a hub included in the rotor assembly for a motor according to the embodiment of the present invention and a disk measured according to a degree of flatness of contact surfaces thereof; and

FIG. 4 is a schematic cut-away exploded perspective view showing a rotor assembly for a motor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

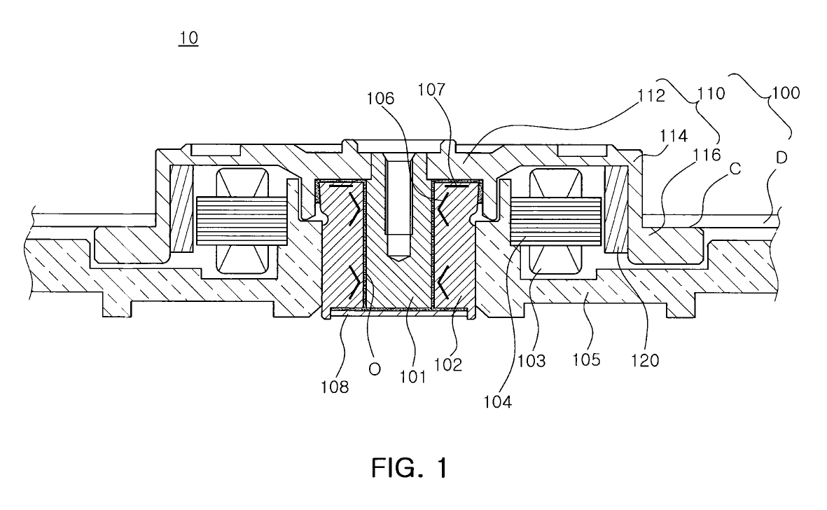

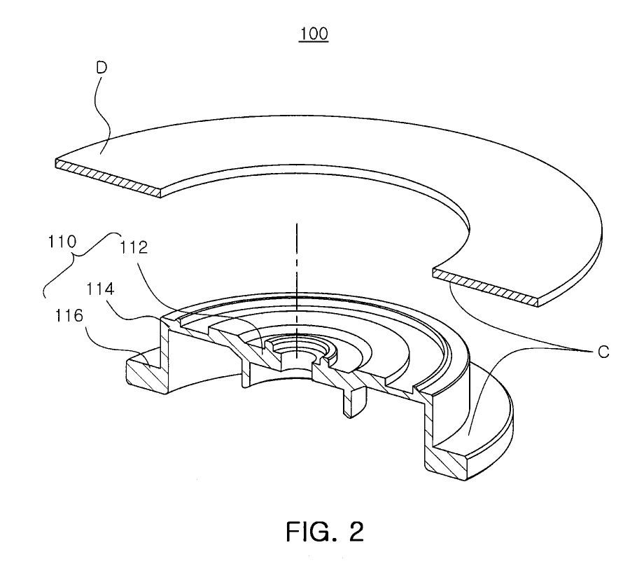

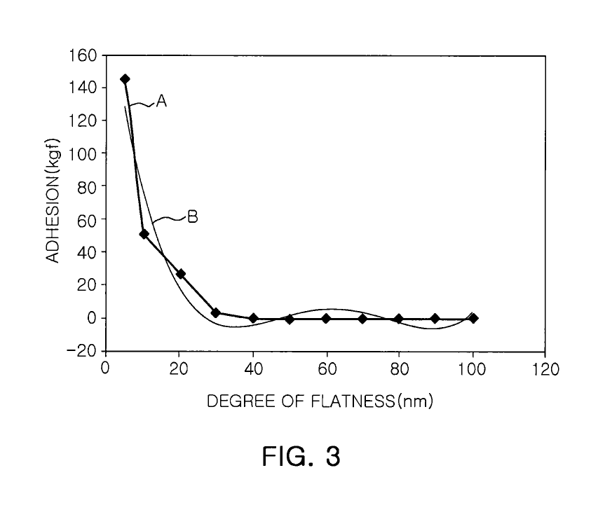

FIG. 1 is a schematic cross-sectional view showing a motor including a rotor assembly for a motor according to an embodiment of the present invention; and FIG. 2 is a schematic cut-away exploded perspective view showing the rotor assembly for a motor according to the embodiment of the present invention. FIG. 3 is a graph showing adhesion between a disk mounting part of a hub included in the rotor assembly for a motor according to the embodiment of the present invention and a disk measured according to a degree of flatness of contact surfaces thereof.

Referring to FIGS. 1 through 3, a motor 10 including a rotor assembly 100 for a motor (hereinafter, referred to as a rotor assembly 100) according to the embodiment of the present invention may include the rotor assembly 100 including a hub 110, a sleeve 102 supporting a shaft 101, and a base 105 having a core 104 coupled thereto.

Terms with respect to directions will be first defined. As viewed in FIG. 1, an axial direction refers to a vertical direction based on the shaft 101, and an outer radial direction or inner radial direction refers to a direction towards an outer edge of the hub 110 based on the shaft 101 or a direction towards the center of the shaft 101 based on the outer edge of the hub 110.

The rotor assembly 100 may include the hub 110 having a disk mounting part 116 on which a disk D may be mounted.

More specifically, the hub 110, a rotating member coupled to the shaft 101 and rotating together therewith, may be a rotating structure provided so as to be rotatable with respect to the base 105.

In addition the hub 110 may Include a coupling part 112 allowing an upper end of the shaft 101 to be fixed thereto and the disk mounting part 116 formed at an outer side of the coupling part 112 in the outer radial direction, and the coupling part 112 and the disk mounting part 116 may be connected and formed integrally with each other by an extension part 114 extended from an end portion of the coupling part 112 in the outer radial direction and then extended downwardly in the axial direction.

Here, the extension part 114 extended downwardly in the axial direction may include a magnet 120 coupled to an inner peripheral surface thereof.

The magnet 120, a permanent magnet generating rotational force having a predetermined strength by having an N pole and an S pole alternately magnetized in a circumferential direction, may electromagnetically interact with a coil 103 to be described below to rotate the hub 110.

Here, the disk D capable of having data stored thereon may be fixed to the disk mounting part 116 of the hub 110 by a contact part 116 with which the disk D is in contact. The contact part 116 may be the disk mounting part 116, as shown in FIGS. 1 and 2.

That is, the disk mounting part 116 of the hub 110 may have the disk D mounted directly thereon, the disk D being capable of having the data stored thereon. The disk D and the disk mounting part 116 may be bonded to each other by an optical contact bonding method in which they are directly bonded to each other without a separate coupling member (for example, a clamp).

Here, the optical contact bonding (optical contact type bonding) method, a method widely used in an optical processing field, indicates an adhesion scheme in which two members are closely adhered or welded to each other without an adhesive by forming the two members using the same material and allowing contact surfaces of the two members to have degrees of flatness, which are almost similar to each other.

This method means a method in which two surfaces to be in contact with each other (that is, contact surfaces) are polished to thereby have improved precision and are closely adhered to each other as flat surfaces to thereby be bonded to each other by a hydrogen bond between hydroxyl groups thereof or a covalent bond due to dehydrogenation condensation.

That is, in the optical contact bonding method, a cleaning process of removing particles and pollutants present on the two contact surfaces in order to improve the precision of the two contact surfaces may be performed. In this cleaning process, various pollutants solidified on the two contact surfaces may be removed using a polishing powder.

Through the processes, two members may be coupled to each other without using an adhesive, a separate coupling member, and generation of a coupling error due to contraction or expansion of the adhesive according to a change in a temperature may be prevented in advance.

When the optical contact bonding method is applied to the rotor assembly 100 according to the embodiment of the present invention, a degree of flatness of contact surfaces C of the disk D and the disk mounting part 116, a contact part 116 with which the disk D is in contact, may be in the range of 0 nm or more to 20 nm or less.

Here, the degree of flatness is a parameter indicating surface roughness. The greater the degree of flatness, the greater the surface roughness.

Here, when adhesion between the disk D and the disk mounting part 116 is measured according to the degree of flatness of the contact surfaces of the disk D and the disk mounting part 116, the contact part 116, at a temperature of 25 C., a curve A in the graph of FIG. 3 may be obtained.

In the graph shown in FIG. 3, a horizontal axis means the degree of flatness of the contact surfaces of the disk D and the disk mounting part 116, the contact part 116, and a vertical axis means the adhesion between the disk D and the disk mounting part 116, the contact part 116.

Here, a unit for degree of flatness is nm, and a unit for adhesion is kgf.

It may be appreciated from the graph shown in FIG. 3 that as degree of flatness of the contact surfaces of the disk D and the disk mounting part 116 the contact part 116 increases adhesion between the disk D and the disk mounting part 116, the contact part 116, exponentially decreases.

Here, in the rotor assembly 100 according to the embodiment of the present invention, adhesion between the disk D and the disk mounting part 116 needs to be 20 kgf or more, and the disk D may be stably rotate under conditions in which adhesion between the disk D and the disk mounting part 116 is maintained to be 20 kgf or more.

Therefore, it may be appreciated that the degree of flatness of the contact surfaces of the disk D and the disk mounting part 116, the contact part 116 needs to be 20 nm or less and is in the numerical range of 0 nm or more to 20 nm or less.

Here, a curve B in the graph shown in FIG. 3 is an approximation curve for representing the curve A in the form of a function. When it is assumed that a horizontal axis of the curve B is X and a vertical axis thereof is Y, the following Equation may be derived.

Y=2*10⁻⁵*X⁴−0.0051 X³+0.4467 X²−16.066*X+198.25

The above Equation may be an equation of the curve B coinciding with the curve A of the graph by 93%. As a result, the above Equation may be a functional equation of the curve A having an error of 7%.

In addition, the contact surfaces of the disk D and the disk mounting part 116, the contact part 116 may be formed of the same material and be coupled to each other.

That is, the disk D and the disk mounting part 116 may be formed of aluminum (Al) or only the contact surfaces C of the disk D and the disk mounting part 116 may be subjected to aluminum (Al) coating.

In addition, the contact surfaces C on which the disk D and the disk mounting part 116 are in contact with each other may surface-contact each other so as not to cause a gap therebeween in order to significantly increase optical contact bonding adhesion.

Therefore, in the rotor assembly 100 according to the embodiment of the present invention, since the disk D may be fixed to the hub 110 by the optical contact bonding method without a disk fixing unit such as a clamp, or the like, warpage of the disk and the hub due to the disk fixing unit such as the clamp, or the like, is prevented and the adhesion between the disk and the hub is improved, whereby performance and a lifespan of the motor may be significantly improved.

The shaft 101, a rotating member coupled to hub 110 to thereby rotate together with the hub 110, may be supported by the sleeve 102.

The sleeve 102 maybe a component supporting the shaft 101, a rotating member. The sleeve 102 may support the shaft 101 such that an upper end of the shaft 101 protrudes upwardly in the axial direction and may be formed by forging Cu or Al or sintering a Cu—Fe based alloy powder or a SUS based power.

In addition, the sleeve 102 may include a shaft hole having the shaft 101 inserted thereinto so as to have a micro clearance therebetween, wherein the micro clearance is filled with oil O, such that the shaft 101 may be stably supported by radial dynamic pressure transferred through the oil O.

Here, the radial dynamic pressure transferred through the oil O may be generated by a fluid dynamic pressure part 106 formed as a groove in an inner peripheral surface of the sleeve 102. The fluid dynamic pressure part 106 may have one of a herringbone shape, a spiral shape, and a helical shape.

However, the fluid dynamic pressure part 106 is not limited to being formed in the inner peripheral surface of the sleeve 102 as described above, but may also be formed in an outer peripheral surface of the shaft 101, the rotating member. In addition, the number of fluid dynamic pressure parts 106 is also not limited.

In addition, the sleeve 102 may include a thrust dynamic pressure part 107 formed on an upper surface thereof so as to generate thrust dynamic pressure transferred through the oil O. The rotating member including the shaft 101 may rotate in a state in which a predetermined floating force is secured by the thrust dynamic pressure part 107.

Here, the thrust dynamic pressure part 107 may be a groove having a herringbone shape, a spiral shape, or a helical shape (screw shape), similar to the fluid dynamic pressure part 106. However, the thrust dynamic pressure part 107 is not necessarily limited to having the above-mentioned shape, but may have any shape as long as the thrust dynamic pressure may be provided thereby.

In addition, the thrust dynamic pressure part 107 is not limited to being formed in the upper surface of the sleeve 102, but may also be formed in a surface of the hub 110 corresponding to the upper surface of the sleeve 102.

Further, the sleeve 102 may include a base cover 108 coupled to a lower portion thereof so as to close the lower portion thereof. The motor 10 according to the embodiment of the present invention may be formed in a full-fill structure by the base cover 108.

The base 105 maybe a fixed member supporting rotation of the rotating member including the shaft 101 and the hub 110.

Here, the base 105 may include the core 104 coupled thereto, wherein the core 104 has the coil 103 wound therearound. The core 104 maybe fixedly disposed on the base 105 including a printed circuit board (not shown) having pattern circuits printed thereon.

In other words, the outer peripheral surface of the sleeve 102 and the core 104 having the coil 103 wound therearound maybe inserted into the base 105, such that the sleeve 102 and the core 104 are coupled to the base 105.

Here, as a scheme of coupling the sleeve 102 and the core 104 to the base 105, a bonding scheme, a welding scheme, a press-fitting scheme, or the like, maybe used. However, the scheme of coupling the sleeve 102 and the core 104 to the base 105 is not necessarily limited thereto.

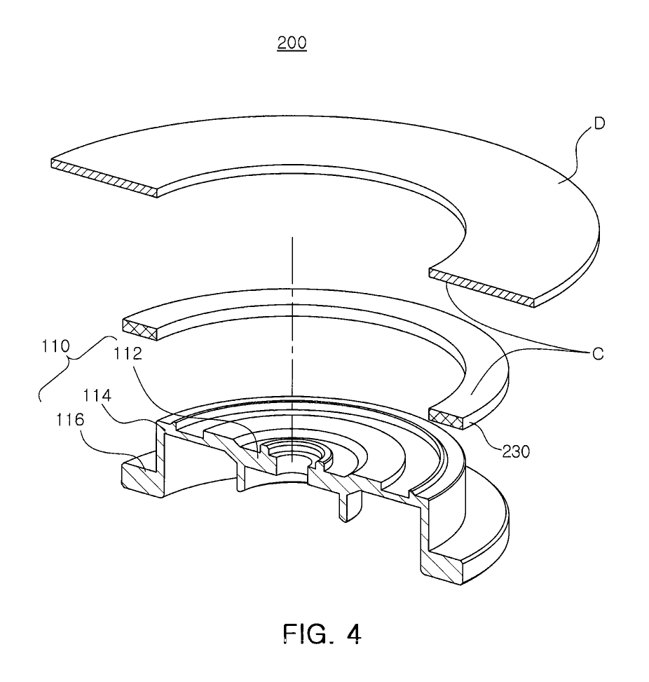

FIG. 4 is a schematic cut-away exploded perspective view showing a rotor assembly for a motor according to another embodiment of the present invention.

Referring to FIG. 4, the rotor assembly 200 according to another embodiment of the present invention is the same as the rotor assembly 100 according to the embodiment of the present invention with reference to FIGS. 1 and 2 except for a contact part 230 with which the disk D is in contact. Therefore, a description of components other than the contact part 230 will be omitted.

The contact part 230 with which the disk D is in contact maybe a spacer 230 allowing the disk mounting part 116 and the disk D to be spaced apart from each other.

That is, the disk D may be fixed to the disk mounting part 116 of the hub 110 through the spacer 230, and the spacer 230 and the disk D may be coupled to each other by the optical contact bonding method.

Here, the spacer 230 may be coupled to an outer peripheral surface of the extension part 114 extended downwardly in the axial direction by a press-fitting scheme a bonding scheme, a welding scheme, or the like. In addition, the spacer 230 may also be coupled to the outer peripheral surface of the extension part 114 by the optical contact bonding method, a coupling method between the spacer 230 and the disk D.

Further, the disk D and the spacer 230, the contact part 230 may surface contact each other so as not to cause a gap therebetween in order to significantly increase optical contact bonding adhesion, and the degree of flatness of the contact surfaces C of the disk D and the spacer 230 maybe in the range of 0 nm or more to 20 nm or less.

In addition, the contact surfaces of the disk D and the spacer 230, the contact part 230 may be formed of the same material and be coupled to each other.

That is, the disk D and the spacer 230 may be formed of aluminum (Al) or only the contact surfaces C of the disk D and the spacer 230 may be subjected to aluminum (Al) coating.

According to the embodiments of the present invention, in the rotor assemblies 100 and 200 for a motor and the motor 10 including the same according to the embodiment of the present invention, since the disk D may be fixed to the hub 110 by the optical contact bonding method without the disk fixing unit (for example, the clamp), the warpage of the disk D and the hub 110 due to the disk fixing unit (for example, the clamp), is prevented and the adhesion between the disk t) and the hub 110 is improved, whereby the performance and the lifespan of the motor may be significantly improved.

As set forth above, in accordance with the rotor assembly for a motor and the motor including the same according to the embodiments of the present invention, the disk can be fixed to the hub without the disk fixing unit (for example, the clamp), a separate member.

Therefore, the warpage of the disk and the hub due to the disk fixing unit (for example, the clamp) can be prevented and the adhesion between the disk and the hub can be improved, whereby the performance and the lifespan of the motor can be significantly improved.

While the present invention has been shown and described in connection with the embodiments, it will be apparent to those skilled in the art that modifications and variations can be made without departing from the spirit and scope of the invention as defined by the appended claims.

What is claimed is:

1. A rotor assembly for a motor, comprising:
a hub including a magnet electromagnetically interacting with a coil to generate rotational driving force; and
a disk mounting part included in the hub and having a disk mounted thereon,
wherein contact surfaces of the disk and a contact part that contacts the disk have a degree of flatness in a range of 0 nm or more to 20 nm or less and are coupled to each other.

2. A rotor assembly for a motor, comprising:
a hub including a magnet electromagnetically interacting with a coil to generate rotational driving force; and
a disk mounting part included in the hub and having a disk mounted thereon,
wherein the disk and a contact part that contacts the disk are coupled to each other by an optical contact bonding.

3. The rotor assembly for a motor of claim 1, wherein the disk and the contact part that contacts the disk are formed of the same material.

4. The rotor assembly for a motor of claim 1, wherein the contact part is a disk mounting part or a space allowing the disk mounting part and the disk to be spaced apart from each other.

5. The rotor assembly for a motor of claim 1, wherein the disk and the contact part surface-contact each other.

6. The rotor assembly for a motor of claim 1, wherein the contact surfaces of the disk and the contact part that contacts the disk are formed of aluminum (Al).

7. A spindle motor comprising:
the rotor assembly for a motor of claim 1;
a sleeve supporting a shaft rotating together with the hub; and
a base coupled to the sleeve and having a core coupled thereto, the core having the coil wound theraround.

8. The rotor assembly for a motor of claim 2, wherein the disk and the contact part that contacts the disk are formed of the same material.

9. The rotor assembly for a motor of claim 2 wherein the contact part is a disk mounting part or a space allowing the disk mounting part and the disk to be spaced apart from each other.

10. The rotor assembly for a motor of claim 2, wherein the disk and the contact part surface-contact each other.

11. The rotor assembly for a motor of claim 2, wherein the contact surfaces of the disk and the contact part that contacts the disk are formed of aluminum (Al).

12. A spindle motor comprising:
the rotor assembly for a motor of claim 2;
a sleeve supporting a shaft rotating together with the hub; and
a base coupled to the sleeve and having a core coupled thereto, the core having the coil wound theraround.
